(19) United States
(12) Patent Application Publication
(10) Pub. No.: US 2005/0127541 A1
(43) Pub. Date: Jun. 16, 2005

(54) Microstructured screen and method of manufacturing using coextrusion

(75) Inventors: Kathryn M. Spurgeon, River Falls, WI (US); Peter F. Cullen, Woodbury, MN (US); Patrick A. Thomas, Maplewood, MN (US); Charlie T. Sobottka, Durand, WI (US); S. Lance Bridges, River Falls, WI (US); Robert S. Moshrefzadeh, Oakdale, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/732,993

(22) Filed: Dec. 11, 2003

(51) Int. Cl. B29D 11/00

(52) U.S. Cl. 264/1.34; 264/1.6; 264/1.7; 264/2.7

(57) ABSTRACT

The present invention is a method of forming an optical film including the following steps: providing a first film of a first material, extruding a second material to form a second film in a molten state; maintaining the second film in a molten state; bringing the first film proximate the molten second film; patterning the molten second film to form a plurality of structures, the structures defining a plurality of cavities therebetween; and solidifying the molten second film.

### CROSS-REFERENCE TO RELATED APPLICATION(S)

This application incorporates by reference co-pending applications Ser. No. ______, filed ______, entitled “Composition for Microstructured Screens” by Peter M. Olofson et al. and Ser. No. ______, filed ______, entitled “Microstructured Screen With Light Absorbing Material and Method of Manufacturing” by Patrick A. Thomas et al.

### BACKGROUND OF THE INVENTION

The present invention is directed generally to methods for manufacturing a rear projection screen and the resulting screen. More particularly, the invention relates to a rear projection screen that incorporates totally internally reflecting structures to disperse the light passing through the screen.

Rear projection screens are generally designed to transmit an image projected onto the rear of the screen into a viewing space. The viewing space of the projection system may be relatively large (e.g., rear projection televisions), or relatively small (e.g., rear projection data monitors). The performance of a rear projection screen can be described in terms of various characteristics of the screen. Typical screen characteristics used to describe a screen's performance include gain, viewing angle, resolution, contrast, the presence of undesirable artifacts such as color and speckle, and the like.

It is generally desirable to have a rear projection screen that has high resolution, high contrast and a large gain. It is also desirable that the screen spread the light over a large viewing space. Unfortunately, as one screen characteristic is improved, one or more other screen characteristics often degrade. For example, the horizontal viewing angle may be changed in order to accommodate viewers positioned at a wide range of positions relative to the screen. However, increasing the horizontal viewing angle may also result in increasing the vertical viewing angle beyond what is necessary for the particular application, and so the overall screen gain is reduced. As a result, certain tradeoffs are made in screen characteristics and performance in order to produce a screen that has acceptable overall performance for the particular rear projection display application.

In U.S. Pat. No. 6,417,966, incorporated herein by reference, Moshrefzadeh et al. disclose a screen having reflecting surfaces disposed so as to reflect light passing therethrough into at least one dispersion plane. The screen thereby permits asymmetric dispersion of image light in a rear projection system and allows the light to be selectively directed towards the viewer. Moshrefzadeh et al. also teach methods for manufacturing the screen, including combinations of steps using casting and curing processes, coating techniques, planarization methods, and removing overcoating materials.

### BRIEF SUMMARY OF THE INVENTION

The present invention is a method of forming an optical film including the following steps: providing a first film of a first material, extruding a second material to form a second film in a molten state; maintaining the second film in a molten state; bringing the first film proximate the molten second film; patterning the molten second film to form a plurality of structures, the structures defining a plurality of cavities therebetween; and solidifying the molten second film.

### BRIEF DESCRIPTION OF THE DRAWINGS

The present invention will be further explained with references to the drawing figures below, wherein like structure is referred to by like numerals throughout the several views.

FIG. 1 is a side elevation view of a microrib screen structure.

FIG. 2 illustrates a method by which the screen structure of claim 1 may be formed.

FIG. 3 is a side elevation view of the structure of FIG. 1 filled with light-absorbing material.

FIG. 4 is a diagram of one embodiment of a method for filling the structure of FIG. 1 to produce the structure of FIG. 3.

FIG. 5 is a side elevation diagram of a step of a second method for filling the structure of FIG. 1 to produce the structure of FIG. 3.

FIG. 6A is a side elevation view of one embodiment of a screen produced by the method of FIG. 5.

FIG. 6B is a side elevation view of a second embodiment of a screen produced by the method of FIG. 5.

FIG. 7 illustrates a second embodiment of a screen of the present invention.

FIG. 8 is a side elevation view of a third embodiment of a screen of the present invention.

FIG. 9 illustrates the structure of FIG. 3 with additional layers.

FIG. 10 is a diagram illustrating one embodiment of a method of the present invention for producing the structure of FIG. 9.

While the above-identified drawing figures set forth several embodiments of the invention, other embodiments are also contemplated. This disclosure presents illustrative embodiments of the present invention by way of representation and not limitation. Numerous other modifications and embodiments can be devised by those skilled in the art which fall within the scope of spirit of the principles of this invention. The drawing figures are not drawn to scale.

Moreover, while the embodiments are referred to by the designations “first,” “second,” “third,” etc., it is to be understood that these descriptions are bestowed for convenience of reference and do not imply an order of preference. The designations are presented merely to distinguish between different embodiments for purposes of clarity.

### DETAILED DESCRIPTION

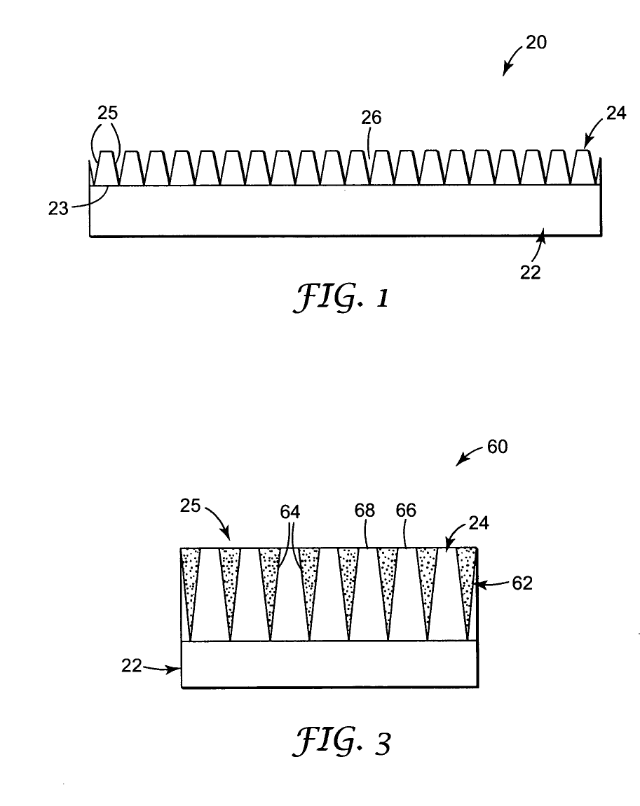

FIG. 1 is a side elevation view of a microrib screen structure. Variations of the illustrated embodiments can be utilized for front projection and other screen applications, but they will be described primarily with reference to rear projection screen applications for the purposes of this disclosure. Microrib structure 20 includes a light transmitting base substrate 22 and microstructured diffusive ribs 24. The term “microstructured” includes features having characteristic dimensions measured in micrometers (μm) or smaller units. In general, microstructured features may have characteristic dimensions ranging from less than 0.01 μm to more than 100 μm. What constitutes a characteristic dimension of a feature depends on the type of feature. Examples include the width of trough-like features in a surface, the height of post-like protrusions on a surface, and the radius of curvature at the point of sharp protrusions or indentations on a surface. Thus, even a macroscopic feature can be said to be microstructured if a characteristic dimension of the feature has dimensions with sub-micrometer tolerances.

In one exemplary embodiment, linear ribs or microribs 24 are formed of an optical-grade host material such as a resin such as polycarbonate; in particular, the host resin incorporates light scattering particles such as beads so that ribs 24 act as a bulk diffuser. A sufficiently high aspect ratio is chosen for the rib geometry in order to induce total internal reflection (TIR) in the microrib structure 20. The loading of the light scattering particles within the resin is chosen to control optical properties such as gain and view angle of the screen. A material such as a resin with a high refractive index (RI) is generally chosen for diffusive ribs 24. In this application, the RI of a rib 24 refers to the RI of the host material. Examples of suitable materials for light diffusive ribs 24 include polymers such as modified acrylics, polycarbonate, polystyrene, polyester, polyolefin, polypropylene, and other optical polymers preferably having a refractive index equal to or greater than about 1.50. Polycarbonate, with a refractive index of 1.59, is particularly useful due to its high glass transition temperature Tg, clarity and mechanical properties. In the embodiment shown in FIG. 1, the light diffusive ribs 24 are separated by V-shaped cavities or grooves 26. While light diffusive structures 24 are described in an exemplary embodiment as ribs that extend across substantially the entire width of base substrate 22, it is also contemplated that the structures 24, in an alternative embodiment, form discrete peaks that can be arranged upon base substrate 22 in a staggered, or “checkerboard” pattern, for example. In an exemplary embodiment, each structure 24 has a base 23 and a plurality of walls 25 which narrow the structure 24 as walls 25 extend from base 23.

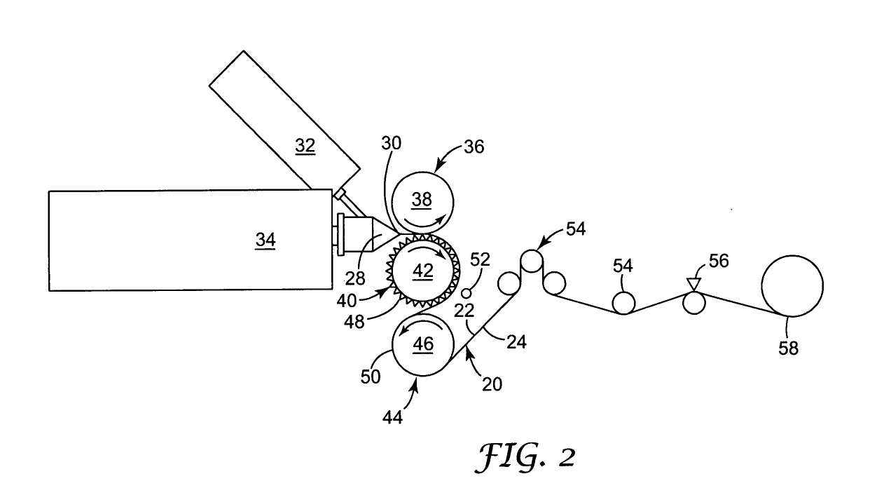

FIG. 2 illustrates a method by which the screen structure of claim 1 may be formed. FIG. 2 shows one example of a microreplication co-extrusion process that can be used to produce microrib structure 20, consisting of diffusive ribs 24 on base substrate 22. The term “microreplication” includes a process whereby microstructured features are imparted from a master or a mold onto an article. The master is provided with a microstructure, for example by micro-machining techniques such as diamond turning, laser ablation or photolithography. The surface or surfaces of the master having the microstructure may be covered with a hardenable material so that when the material is hardened, an article is formed that has a negative replica of the desired microstructured features. The microreplication may be accomplished using rolls, belts, and other apparatuses known in the art.

Microreplication can be accomplished by techniques including but not limited to extruding, embossing, radiation curing and injection molding.

In one exemplary embodiment shown in FIG. 2, co-extrusion die 28 is a high-temperature, high-pressure die for the simultaneous extrusion of a two-layer film. In one embodiment, die 28 has an extruder orifice diameter 30 of about 44.4 mm (1.75 inch) to about 50.8 mm (2 inches). The two-layer film is composed of material 32 to form base substrate 22 and material 34 to form light diffusive ribs 24.

In one embodiment, materials 32 and 34 are heated to about 66° C. (150° F.) and extruded simultaneously from die 28, which has a temperature of about 293° C. (560° F.). Each material 32 and 34 is isolated from the other until after they are extruded from die 28. After extrusion, the materials 32 and 34 are brought into contact with each other, wherein at least material 34 is still in a molten state.

The three-roll extrude-emboss technique shown in FIG. 2 uses a first roll 36, a patterned second roll 40, and a third roll 44. In one embodiment, each roll 36, 40 and 44 is about 0.43 m (17 inches) in diameter. First roll 36 and third roll 44 may be heated or chilled as required by the nature of the materials used to facilitate release of the materials from the roll surfaces. Materials 32 and 34 are simultaneously extruded from die 28 onto patterned roll 40. In the illustrated embodiment, material 32 is extruded proximate nip roll 36 and material 34 is extruded proximate patterned cast roll 40. In one embodiment, first or nip roll 36 is heated to greater than or about 52° C. (125° F.) by running heated oil through interior 38 of roll 36, the oil being heated by an external heat source. In one exemplary embodiment, nip roll 36 is formed of a material such as silicone rubber.

Cast roll 40 is patterned on outer surface 48 to impart the desired structures upon material 34 to result in light diffusive ribs 24. In one exemplary embodiment, cast roll 40 is formed of a metal such as chromium, nickel, titanium, or an alloy thereof. In one embodiment, cast roll 40 is heated to greater than or about 204° C. (400° F.), more particularly between about 252° C. (485° F.) and about 282° C. (540° F.), by running heated oil through interior 42 of roll 40, the oil being heated by an external heat source. Third or carrier roll 44 is generally heated or chilled by running oil or water through interior 46 of roll 44 to assist in the release of microrib structure 20 from cast roll 40. In one embodiment, carrier roll 44 is heated to greater than or about 66° C. (150° F.) by running heated oil through interior 46 of roll 44, the oil being heated by an external heat source. In one exemplary embodiment, carrier roll 44 has a smooth outer surface 50 and is formed of a metal such as chromium, nickel, titanium, or an alloy thereof.

In one embodiment, material 32 for forming base structure 22 is a light transmitting material such as a clear polymer such as polycarbonate, polyester, polyolefin, polypropylene, acrylic or vinyl, for example. In one embodiment, material 34 for diffuser ribs 24 is a high refractive index polymer such as a modified acrylic, polycarbonate, polystyrene, polyester, polyolefin, polypropylene, or other optical polymer. It is particularly suitable for material 34 to have a refractive index greater than or equal to about 1.50. Polycarbonate, with a RI of 1.59 is particularly useful due to its high Tg, clarity and mechanical properties. In one embodiment, material 32 and material 34 are compatible so that they physically bond at the interface therebetween to integrate into a monolithic structure. This is achieved in one exemplary embodiment by using the same polymer material for material 32 and 34, the difference being that material 34 incorporates light diffusing particles into the polymer. In an alternate embodiment, material 32 and material 34 can have different compositions, but they possess similar processing characteristics and bond to one another at their interface.

In one embodiment, nip roll 36 and cast roll 40 are in intimate contact to provide high pressure compression of materials 32 and 34, and particularly material 34, against cast roll 40. This is especially important for materials with a high Tg such as polycarbonate, which set up almost immediately upon exiting die 28. Carrier roll 44 need not be in intimate contact with cast roll 40; the purpose of carrier or pull roll 44 is merely to take formed microrib structure 20 off cast roll 40. In one embodiment, each roll 36, 40 and 44 rotates at about 3.6 m (12 feet) per minute, with adjacent rolls rotating in opposite directions.

In one embodiment, air bar 52 facilitates the release of structure 20 off cast roll 40. Air bar 52 is a perforated cylinder which emits cooling air onto structure 20 just before the point of separation of structure 20 from cast roll 40. In one embodiment, air is supplied at about 620 kPa (90 psi) and ambient temperature. Materials 32 and 34 solidify into structure 20. In one embodiment, tensioning roll assembly 54 is used to provide the proper amount of tension on structure 20 as it travels. Slitter 56 is provided to cut structure 20 to desired widths. Windup roll 58 winds up structure 20 for storage or later retrieval.

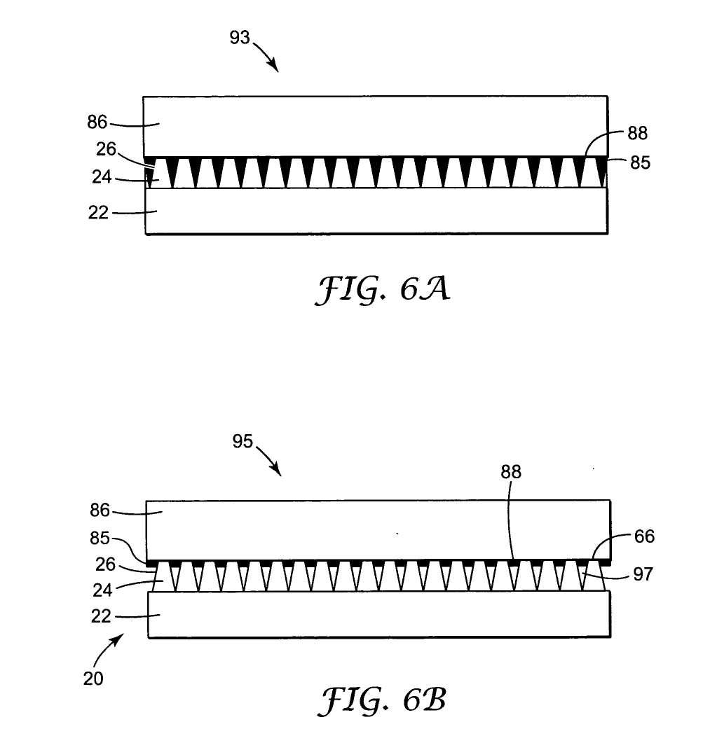

Other cast-emboss and extrude-emboss methods, for example, can also be used. The resulting microrib structure 20 can then be used in the method described with reference to FIGS. 5, 6A and 6B. In another embodiment, single layer extrusion can be used to extrude material 34 for forming light diffusive ribs 24 onto previously formed substrate 22. In this embodiment, an input feeds substrate 22 so that material 34 in a molten state is extruded thereon. Both materials are pressed together by nip roll 36 so that material 34 is patterned by cast roll 40. Substrate 22 and material 34 remain in intimate contact during the cooling phase.

Referring to FIG. 5, co-extrusion can also be used to extrude the dual layer of shield 86 and light absorbing adhesive 85. Suitable optical materials for light absorbing adhesive 85 include those discussed with reference to FIGS. 5, 6A and 6B, for example.

FIG. 3 is a side elevation view of the structure of FIG. 1 filled with light-absorbing material 62. Embedded microstructured film 60 includes filling material 62. Material 62 typically incorporates a black pigment or dye to absorb ambient light and improve contrast in the final screen construction. Material 62 has a low refractive index so that a relatively high difference in refractive index exists between light absorbing material 62 and the material composing light diffusive ribs 24. A refractive index difference of at least about 0.06 is desired. Such a difference induces efficient internal reflection and high screen performance. In one exemplary embodiment, microrib structure 20 is filled with a black pigmented high melt flow PMMA light absorbing material 62. This construction yields a desirably high refractive index difference of about 0.08 to 0.09 between light absorbing material 62 and ribs 24. Internally reflecting surfaces 64 are formed by the interfaces between light diffusive ribs 24 and light absorbing material 64. In one exemplary embodiment, front surface 66 of embedded microstructured film 60 is a smooth or slightly matte surface with minimal land on the rib top surfaces 68. Totally internally reflecting surfaces 64 disperse light through optically transmitting areas 68 of front surface 66. Front surface 66 preferably has a matte surface finish that assists in scattering the light propagating therethrough.

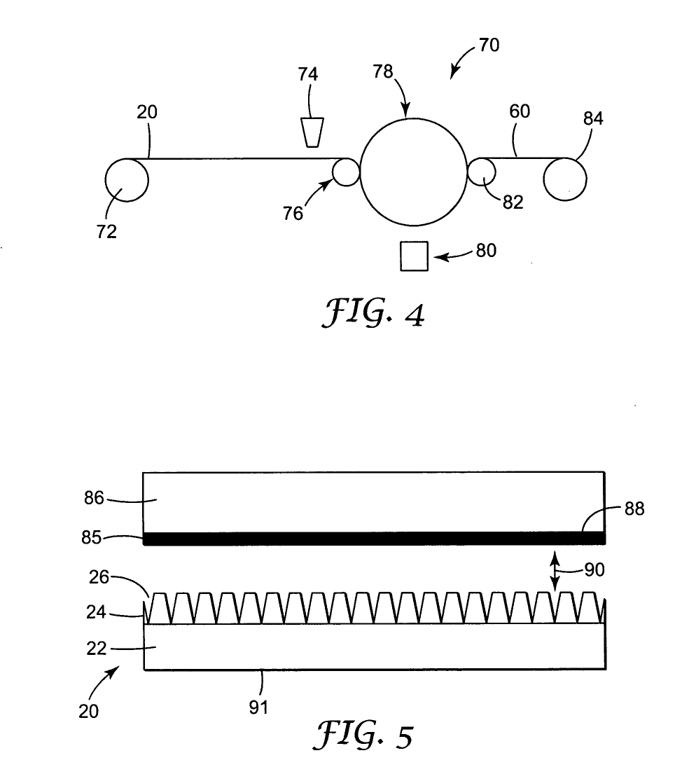

FIG. 4 is a diagram of one embodiment of a method for filling structure 20 of FIG. 1 to produce structure 60 of FIG. 3. Planarization process 70 coats light absorbing material 62 onto the microrib structure 20 to form embedded microstructured film 60. Planarization process 70 uses resin coating station 74, precision nip roll 76, a smooth, matte or microstructured cylinder 78, ultraviolet lamp 80, precision nip roll 82 and embedded microstructured film rewind 84.

Microrib structure 20 is first unwound from substrate unwind station 72. Microrib structure 20 continues on to resin coating station 74, where it is overcoated with light absorbing material 62. The composite structure is pressed by precision nip roll 76 against cylinder 78. Cylinder 78 may be smooth, matte or microstructured to impart a desired texture upon front surface 66 of the resulting embedded planar microstructured film 60 shown in FIG. 3. After light absorbing material 62 is cast onto microrib structure 20, the film proceeds to be cured by ultraviolet lamp 80. A completed embedded microstructured film 60 emerges from precision nip roll 82 to be wound upon embedded microstructured film rewind 84.

FIG. 5 is a side elevation diagram of a step of a second method for filling structure 20 of FIG. 1 to produce structure 60 of FIG. 3. In one embodiment of the method of the present invention, microrib structure 20 is formed by the co-extrusion process discussed above with respect to FIG. 2 to impart light diffusive ribs 24 having V-shaped grooves 26 onto base structure 22. An alternate filling process illustrated in FIG. 5 eliminates the planarization process 70 shown in FIG. 4 and additionally laminates a protective shield to microrib structure 20. This is achieved by introducing a light absorbing adhesive 85 which serves both light absorbing and adhesive functions. The term “adhesive” used with reference to light absorbing adhesive 85 need not be an adhesive in the normal sense, but needs only to have bonding capabilities with light diffusive ribs 24, and also to shield 86 if used. By combining the light absorption and adhesive functions in one material, savings in materials and manufacturing steps are obtained. Light absorbing adhesive 85 is disposed on rear surface 88 of shield 86. Shield 86, with light absorbing adhesive 85 disposed thereon, is brought together with microrib structure 20. As shown by arrow 90, for example, shield 86 and microrib structure 20 are laminated together.

The thickness of light transmitting base film 22 can be chosen to meet the requirements of each particular application. For example, a thin base film with a thickness of about 0.127 mm (5 mils) to about 0.254 mm (10 mils) can be chosen to provide for ease of manufacturing; alternatively, a thick film with a thickness of about 0.508 mm (20 mils) to about 1.016 mm (40 mils) can be chosen to provide additional product stiffness. Suitable materials include polycarbonate, polyester, acrylic and vinyl films, for example. In one exemplary embodiment, back surface 91 of base substrate 22 has a matte finish to reduce specular reflection back into the imaging system.

Shield 86 can also be varied to provide for different functionalities. Shield 86 can range in thickness from thin (less than about 0.508 mm (20 mils)) to semi-rigid (about 0.508 mm (20 mils) to about 1.016 mm (40 mils)) to rigid (greater than about 1.016 mm (40 mils)). The thickness of base substrate 22 and protective shield 86 can be chosen to yield a wide variety of products with these options impacting total material cost, optical functionality, and ease of processing. In one exemplary embodiment, light diffusive ribs 24 are formed of a polycarbonate loaded with light diffusing particles. In one exemplary embodiment, shield 86 is a clear PMMA.

In one exemplary embodiment, light absorbing adhesive 85 is a photopolymerizable, low refractive index material which adheres to both light diffusive ribs 24 and shield 86. In an exemplary embodiment, the refractive indices of light diffusive ribs 24 and light absorbing adhesive 85 differ enough to cause total reflection rather than transmittance at the interface therebetween. In an exemplary embodiment, the refractive index of the microrib material of light diffusive ribs 24 varies from 1.49 for simple acrylate materials to 1.58 or higher for materials such as aromatic polycarbonates. The refractive index requirement for the groove filler material 85 is, therefore, dependent on the optical properties (such as refractive index) of the microrib 24 material. For the high refractive index microrib materials, such as polycarbonate, commercially available photolaminating adhesives may be adequate. Exemplary adhesives 85 have a RI of less than about 1.50. Particularly suitable adhesives 85 have a RI of less than about 1.45. In some embodiments, adhesive 85 is a pigmented blend of one or more of the following components: urethane acrylate oligomers; substituted acrylate, diacrylate, and triacrylate monomers; fluorinated acrylates; perfluoroalkylsulfonamidoalkyl acrylates; acrylated silicones, acrylated silicone polyureas and UV or visible light activated photoinitiators.

If the viscosity of the groove filler 85 is too low, it will flow during the groove filling process. This can waste material, give nonuniform thickness, and contaminate the process equipment. If the viscosity is too high, filling the grooves 24 can be a slow, difficult process and the possibility of introducing bubbles (optical defects) increases significantly. While photolamination can be accomplished with fluids having viscosities as low as about 150 centipoises, many processes can benefit from a viscosity of at least about 400 centipoises before polymerization. While viscosities as high as about 5,000 centipoises before polymerization can be used, viscosities no higher than about 1,500 centipoises before polymerization are especially suitable for reasonable process speed and bubble-free coatings.

A standard measure of adhesion between substrates and coatings is the amount of force required to separate them, known as the peel force. The peel force of a system containing excellent interfacial adhesion at the interface between layers will be very high. While peel force strength of at least about 35.7 kg/m (2 pounds/inch) is probably adequate between polycarbonate diffusive ribs 24 and light absorbing adhesive 85, it is more desirable to have peel force of at least about 71.4 kg/m (4 pounds/inch). This high peel force should be maintained under environmental test conditions of high temperature and humidity. Adequate adhesion may be achieved by modification of the substrate surfaces by treatment, such as with corona discharge or plasma, or priming; it is preferred, however, that the adhesive 85 adhere to the light diffusive ribs 24 and shield 86, if used, without the necessity of surface modification.

One suitable embodiment of light absorbing adhesive 85 is constructed by warming the following resin components to about 70° C. (158° F.) to lower the viscosity sufficiently to allow for agitation: 16.0 g aliphatic urethane acrylate oligomer; 19.0 g ethoxyethoxyethyl acrylate; 5.5 g hexanediol diacrylate; 5.0 g tetrahydrofurfuryl acrylate; 44.5 g N-methyl-perfluorobutylsulfonamidoethyl acrylate; 10.0 g acryloyloxyethoxyperfluorobutane; and 1.0 g phenyl bis(2,4,6 trimethyl benzoyl) phosphine oxide photoinitiator.

The components are then shaken until a clear solution results. The solution is then pigmented for light absorption. One suitable pigment is carbon black; in one exemplary embodiment, the pigment is used in a concentration between about 50 ppm (parts per million) and about 20,000 ppm; in one exemplary embodiment, the pigment is used in a concentration greater than about 1,000 ppm and less than about 9,000 ppm. A concentration of about 3,000 ppm is particularly suitable, based on mass ratios of the carbon black material to the resin material. In one embodiment, the formulation is disposed onto shield 86 by a conventional method such as knife coating. The coated shield is then pressed onto microrib structure 20 as shown in FIG. 5, for example, to partially or completely fill grooves 26. Excess adhesive 85, if any, is expelled by running a rubber roller over the construction. The construction is passed under a 11.81 W/mm (300 Watt/in) Fusion Systems D lamp several times at about 6.1 m (20 feet) per minute. In an alternate method, the formulation may be coated directly onto the microrib structure 20, and shield 86 then adhered to the microrib structure 20 with adhesive 85 already disposed thereon. Thereafter, the steps of removing excess adhesive 85 and curing the construction are the same as discussed above.

FIG. 6A is a side elevation view of one embodiment of a screen produced by the method of FIG. 5. The step of FIG. 5 can result in a completely filled structure 93 illustrated at FIG. 6A. In one exemplary embodiment, light absorbing adhesive 85 has a low refractive index to produce efficient TIR within ribs 24. Light absorbing adhesive 85 is formulated to effectively bond diffuser ribs 24 to shield 86. Light absorbing adhesive 85 can possess low shrinkage properties to produce a cosmetically acceptable lamination result. Moreover, it is particularly suited that light absorbing adhesive 85 is curable by ultraviolet light in order to allow for convenient processing and a fast cure.

In one embodiment, light diffusive ribs 24 are replicated from a tooling mold using a high refractive index diffuser resin, as shown in the coextrusion process of FIG. 2. In this application, all percentages are by mass unless otherwise indicated. One suitable resin is about 79% aliphatic urethane acrylate oligomer, about 19% 2-phenoxyethyl acrylate, and about 2% 2-hydroxy-2-methyl-1-phenyl-1-propanone photoinitiator. Another suitable resin is about 69% aliphatic urethane acrylate oligomer, about 29% 2-(1-naphthyloxy)-ethyl acrylate and about 2% 2-hydroxy-2-methyl-1-phenyl-1-propanone photoinitiator.

Then, a pigmented, typically black, light absorbing adhesive 85 is applied to a second substrate such as shield 86. One suitable light absorbing adhesive 85 is formed from a resin having about 30% “Formulation A,” (the “Formulation A” having about 38.5% aliphatic urethane acrylate oligomer, about 26.9% ethoxyethoxyethyl acrylate, about 28.8% isobornyl acrylate, about 5.8% hexanediol diacrylate and about 1% α,α-diethoxyacetophenone (DEAP) photoinitiator); about 10% aliphatic urethane diacrylate; about 30% trifluoroethyl acrylate; and about 30% N-methyl-perfluorobutylsulfonamidoethyl acrylate. Another suitable light absorbing material 85 is formed from a resin having about 50% “Formulation A,” discussed above, and about 50% N-methyl-perfluorobutylsulfonamidoethyl acrylate. In one exemplary embodiment, light absorbing adhesive 85 contains a pigment such as carbon black. In one exemplary embodiment, the pigment is used in a concentration between about 50 ppm and about 20,000 ppm. In one exemplary embodiment, the pigment is used in a concentration greater than about 1,000 ppm and less than about 9,000 ppm. A concentration of about 3,000 ppm is particularly suitable, based on mass ratios of the carbon black material to the adhesive material.

Light absorbing adhesive 85 can be applied to a second substrate such as shield 86 in sufficient quantity to completely fill diffuser ribs 24, allowing a slight excess to ensure complete fill, in the lamination method illustrated in FIG. 5. The excess adhesive squeezes out of completely filled structure 93 upon lamination. Completely filled structure 93 is then exposed to radiation under conditions similar to those discussed above for microreplication process 120. The exposure can, for example, result in a partial or complete polymerization of the material. After at least partial polymerization, light absorbing adhesive 85 is a copolymer of its components.

FIG. 6B is a side elevation view of another embodiment of a screen produced by the method of FIG. 5. When a small thickness or amount of light absorbing adhesive 85 is used in the step illustrated in FIG. 5, partially filled structure 95 results. In partially filled structure 95, air gaps 97 are left in V-shaped grooves 26. A benefit of air gap 97 is that the low refractive index air fills the rib grooves 26 and creates a large refractive index difference between the grooves 26 and the light diffusive ribs 24, further enhancing “TIR efficiency.” Because the refractive index of air is 1.0, the difference in refractive index between air gap 97 and light diffusive ribs 24 is usually greater than about 0.5. Because air gap 97 creates the bulk of the diffuser rib interface, light absorbing adhesive 85 need not possess as low a refractive index as when the ribs are completely filled in structure 93. This allows for the selection of an adhesive 85 to optimize other important properties, such as low shrinkage and high peel strength adhesion, for example. Since the adhesive contact area between light absorbing adhesive 85 and diffuser ribs 24 is smaller, light absorbing adhesive 85 may possess greater adhesive properties in partially filled structure 95 than completely filled structure 93.

In both completely filled structure 93 and partially filled structure 95, the level of light absorbing material used in light absorbing adhesive 85 is chosen based on the desired amount of contrast enhancement and ambient light absorption. The light absorbing material in an exemplary embodiment is a black pigment such as carbon black. In completely filled structure 93, the black pigment concentration can be relatively low and yet yield an acceptable total fixed absorbence, or optical density value, because the thickness of the layer of light absorbing adhesive 85 is large. A suitable loading concentration of pigment such as carbon black in completely filled structure 93 in one embodiment is between about 50 ppm and about 20,000 ppm. In an exemplary embodiment, the concentration is greater than about 1,000 ppm and less than about 9,000 ppm. A concentration of about 3,000 ppm is particularly suitable, based on mass ratios of the carbon black material to the adhesive material. However, in partially filled structure 95, the coating thickness is small; therefore, the black pigment concentration must be larger to yield the same optical density. In the latter case, the ambient light absorption is larger per unit of coating thickness than in the former case. A suitable loading concentration of pigment such as carbon black in partially filled structure 95 in one embodiment is between about 50 ppm and about 20,000 ppm. In an exemplary embodiment, the concentration is greater than about 5,000 ppm and less than about 10,000 ppm, based on mass ratios of the carbon black material to the adhesive material.

A challenge in both completely filled structure 93 and partially filled structure 95 is the removal of excess adhesive 85 from front surface 66 of diffuser ribs 24 during lamination. If all of the light absorbing adhesive 85 is not removed from front surface 66 of the diffuser ribs 24 during lamination, some image light can be lost due to absorption during TIR transmission. In a partially filled structure 95 with more highly pigmented adhesive 85, more loss of image light can occur for the same residual black layer thickness.

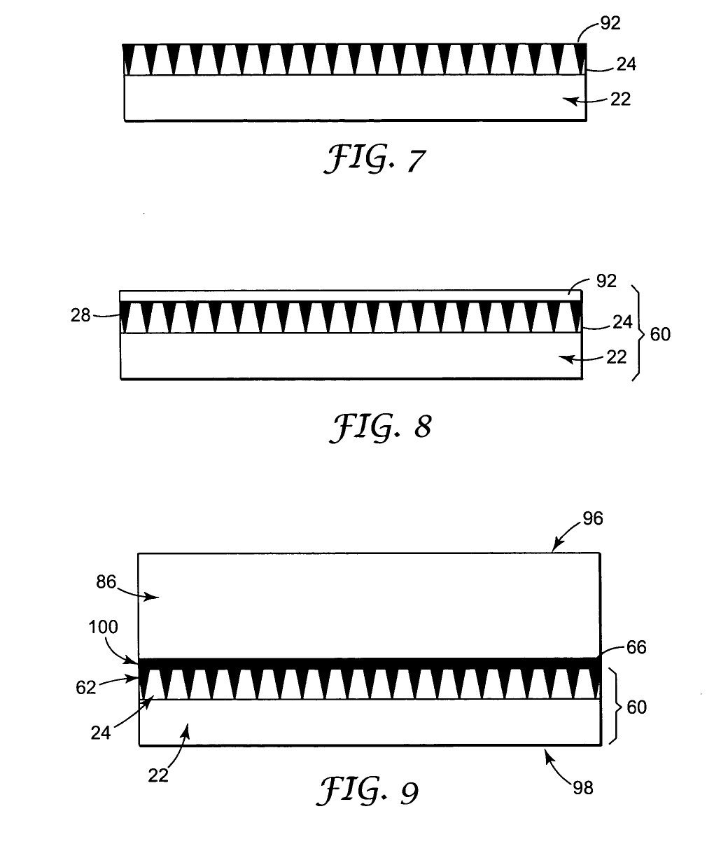

FIG. 7 illustrates a second embodiment of a screen of the present invention. In one embodiment, overcoat layer 92 is made of a material which is multifunctional to serve as a low refractive index component as well as a hard coat. In this way, the “TIR efficiency” is maintained, but the potential need to laminate to a protective shield is eliminated since the material of overcoat layer 92 is scratch-resistant due to its inherent hard properties. This combination of functions within one material further reduces material usage and costs. Suitable materials for overcoat layer 92 include hard coat materials incorporating a pigment such as carbon black. In one embodiment, the pigment is used in a concentration between about 50 ppm and about 20,000 ppm. In an exemplary embodiment, the concentration is greater than about 1,000 ppm and less than about 9,000 ppm. A concentration of about 3,000 ppm is particularly suitable, based on mass ratios of the carbon black material to the hard coat material.

One suitable hard coat material is disclosed in U.S. Pat. No. 5,104,929 to Bilkadi, hereby incorporated by reference. Bilkadi teaches a photocurable abrasion resistant coating including colloidal silicon dioxide particles dispersed in ethylenically unsaturated aliphatic and/or cycloaliphatic monomers that are substituted by a protic group. In particular, the coating composition curable to an abrasion and weather resistant coating includes a non-aqueous dispersion of colloidal silicon dioxide particles of diameters less than about 100 nanometers in a protic group-substituted ester or amide of acrylic or methacrylic acid.

Another suitable hard coat material is disclosed in U.S. Pat. No. 5,633,049 to Bilkadi, hereby incorporated by reference. Bilkadi teaches an acid- and abrasion-resistant coating prepared from a silica-free protective coating precursor composition including a multifunctional ethylenically unsaturated ester of acrylic acid, a multifunctional ethylenically unsaturated ester of methacrylic acid, or a combination thereof; and an acrylamide.

Other hard coat materials include room-temperature curing silicone resins derived from functionalized silane monomers; coatings derived from hydrolyzable silanes; polymers derived from a combination of acryloxy functional silanes and polyfunctional acrylate monomers; polymers such as acrylic with colloidal silica; and polymerized acrylate or methacrylate functionalities on a monomer, oligomer or resin; for example.

FIG. 8 is a side elevation view of a third embodiment of a screen of the present invention. Embedded microstructured film 60 is provided with a hard coat 94 to protect the film against scratching and other damage. Hard coat 94 may be applied by spraying, dipping, or roll coating, for example. This process eliminates the need for a separate protective shield 86.

FIG. 9 illustrates the structure of FIG. 3 with additional layers: Shielded screen 96 incorporates embedded microstructured film 60 with back surface 98 and adhesive 100 on front surface 66 for the attachment of a light transmitting shield 86. Shield 86 is a protective layer that can be a film or sheet made of transparent material such as acrylic, polycarbonate or glass, for example. Shield 86 functions as a protective element so that embedded microstructured film 60 is not damaged by contact. Shield 86 is an optional component, though most applications benefit greatly from this protection. Shield 86 can be made to be anti-glare (matte), anti-reflective, anti-static, anti-scratch or smudge resistant, for example, through coatings, surface textures, or other means. In one embodiment, shield 86 is a 3 millimeter thick acrylic panel from Cyro Corporation with a non-glare, matte outward-facing surface.

The thickness of base film 22 can be chosen to meet the requirements of each particular application. For example, a thin base film with a thickness of about 0.127 mm (5 mils) to about 0.254 mm (10 mils) can be chosen to provide for ease of manufacturing; alternatively, a thick film with a thickness of about 0.508 mm (20 mils) to about 1.016 mm (40 mils) can be chosen to provide additional product stiffness. Suitable materials include polycarbonate, polyester, acrylic, polyolefin, polypropylene and vinyl films, for example. In one exemplary embodiment, back surface 98 of embedded microstructured film 60 has a matte finish to reduce specular reflection back into the imaging system.

Shield 86 can also be varied to provide for different functionalities. Shield 86 can range in thickness from thin (less than about 0.508 mm (20 mils)) to semi-rigid (about 0.508 mm (20 mils) to about 1.016 mm (40 mils)) to rigid (greater than about 1.016 mm (40 mils)). The thickness of base substrate 22 and protective shield 86 can be chosen to yield a wide variety of products with these options impacting total material cost, optical functionality, overall construction stiffness and ease of processing. In one exemplary embodiment, light diffusive ribs 24 are formed of a polycarbonate loaded with light diffusing particles.

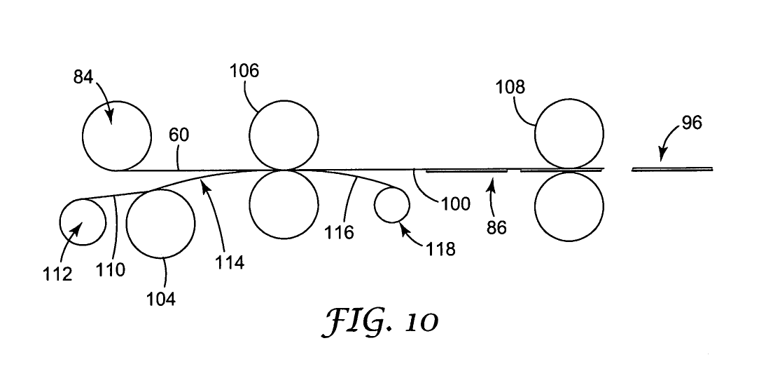

FIG. 10 is a diagram illustrating one embodiment of a method of the present invention for producing the structure of FIG. 9. In one embodiment, lamination process 102 directly follows the planarization or filling process in a single assembly line. Lamination process 102 uses adhesive unwind 104, lamination nip assembly 106 and lamination nip assembly 108. Either of lamination nip assemblies 106 or 108 may be driven, or separate drive wheels or other drive mechanisms can be used to propel components through process 102. The adhesive material disposed on adhesive unwind 104 is typically a layer of pressure-sensitive adhesive 100 sandwiched between two liner layers. When the adhesive material is unwound from adhesive unwind 104, top liner 110 is separated therefrom and wound upon top liner rewind 112. The remaining adhesive material 114 is contacted with embedded microstructured film 60, which is unwound from film unwind 84. Embedded microstructured film 60 and adhesive material 114 pass through lamination nip 106, where they are pressed together.

Thereafter, bottom liner 116 of the adhesive composite 114 is removed and wound onto bottom liner rewind 118. A shield 86 is introduced on a transversely traveling feed web or other suitable mechanism and disposed onto the exposed adhesive 100. The structure then passes through lamination nip 108, where shield 86 is pressed onto microstructured film 60 and adhered thereto by adhesive 100. The embedded microstructured film 60 can be severed between discrete shields 86 to form individual shielded screens 96.

Although the present invention has been described with reference to exemplary embodiments, workers skilled in the art will recognize that changes may be made in form and detail without departing from the spirit and scope of the invention. For example, while particular shapes for light diffusive and light absorbing structures are illustrated, it is contemplated that the structures may be formed in different shapes, incorporating additional or different planes or angles, additional edges, and curved surfaces. It is further noted that the light diffusive structures on a particular substrate need not all be of the same height or shape, for example. Similarly, the light absorbing structures on a particular substrate need not all be of the same height or shape, for example. Moreover, components of the materials and processes described therein are combinable in numerous ways; only a few of those possibilities have been specifically described by way of example, although all are regarded to be within the scope of the invention.

1. A method of forming an optical film comprising:
providing a first film of a first material,
extruding a second material to form a second film in a molten state;
maintaining the second film in a molten state;
bringing the first film proximate the molten second film;
patterning the molten second film to form a plurality of structures, the structures defining a plurality of cavities therebetween; and
solidifying the molten second film.

2. The method of claim 1 further comprising at least partially filling the plurality of cavities with an optical material.

3. The method of claim 2 wherein the optical material is light absorbing.

4. The method of claim 1 in which the first material and the second material are of a same polymer composition.

5. The method of claim 2 in which the optical material includes a black pigment.

6. The method of claim 2 and further comprising laminating a shield to the plurality of structures and the optical material.

7. The method of claim 2 and further comprising disposing a hard coat adjacent the plurality of structures and adjacent the optical material.

8. The method of claim 1 in which each structure comprises a rib.

9. The method of claim 1 in which the first material comprises a light transmitting material and the second material comprises the light transmitting material and a plurality of light diffusing particles.

10. The method of claim 1 in which:
the step of providing the first film includes extruding the first material proximate a nip roll;
the step of extruding the second material includes extruding the second material proximate a cast roll;
the step of extruding the first material is performed simultaneously with the step of extruding the second material; and
the step of patterning the second film to form a plurality of structures includes compressing the second material against the cast roll to impart a pattern cast on the roll onto the second material.

11. The method of claim 10 in which the cast roll is formed of a metal selected from the group consisting of chromium, nickel, titanium, or an alloy thereof.

12. The method of claim 10 in which the nip roll rotates in a first direction and in which the cast roll rotates in a second direction opposite the first direction.

13. The method of claim 12 further comprising:
removing the optical film from the cast roll by winding the film about a carrier roll, the carrier roll rotating in the first direction.

14. The method of claim 13 further comprising:
heating the carrier roll.

15. The method of claim 14 further comprising:
running heated oil through an interior of the carrier roll.

16. The method of claim 14 further comprising:
heating the cast roll to greater than or about 66° C.

17. The method of claim 13 further comprising:
cooling the carrier roll.

18. The method of claim 17 further comprising:
running water through an interior of the carrier roll.

19. The method of claim 13 in which the carrier roll is formed of a metal selected from the group consisting of chromium, nickel, titanium, or an alloy thereof.

20. The method of claim 13 further comprising:
cooling the film by supplying air thereto prior to removing the film from the cast roll.

21. The method of claim 20 in which the step of cooling the film includes supplying air at about 620 kPa.

22. The method of claim 10 further comprising:
heating the nip roll.

23. The method of claim 22 further comprising:
heating the nip roll to greater than or about 52° C.

24. The method of claim 22 further comprising:
running heated oil through an interior of the nip roll.

25. The method of claim 10 further comprising:
cooling the nip roll.

26. The method of claim 10 further comprising:
heating the cast roll.

27. The method of claim 26 further comprising:
heating the cast roll to greater than or about 204° C.

28. The method of claim 27 further comprising:
heating the cast roll to greater than or about 252° C.

29. The method of claim 27 further comprising:
heating the cast roll to less than or about 282° C.

30. The method of claim 26 further comprising:
running heated oil through an interior of the cast roll.

31. The method of claim 10 in which the nip roll is formed of silicone rubber.

32. The method of claim 1 in which the steps of providing the first film and extruding the second material include heating a die for simultaneously extruding the first material and the second material.

33. The method of claim 32 in which the die is heated to about 293° C.
